(19) United States
(12) Patent Application Publication
(10) Pub. No.: US 2002/0083644 A1
(43) Pub. Date: Jul. 4, 2002

(54) Hydrogen manufacturing method and hydrogen manufacturing system

(76) Inventors: Naoaki Sata, Tokyo (JP); Tsunenori Yanagisawa, Tokyo (JP); Arata Toyoda, Tokyo (JP)

Correspondence Address: KATTEN MUCHIN ZAVIS ROSENMAN, 575 MADISON AVENUE, NEW YORK, NY, 10022-2585, US

(21) Appl. No.: 10/033,504

(22) Filed: Dec. 27, 2001

(30) Foreign Application Priority Data
Dec. 28, 2000 (JP) 2000-400916
Mar. 7, 2001 (JP) 2001-062981

(51) Int. Cl. C01B 3/24; B01J 7/00; C10J 1/00

(52) U.S. Cl. 48/61; 423/650; 423/653; 48/76

(57) ABSTRACT

A method for manufacturing hydrogen from a raw material that contains a chemical compound from which hydrogen is hardly obtainable, includes the steps of: converting the chemical compound from which hydrogen is hardly obtainable into a chemical compound from which hydrogen is obtainable by a conversion reaction; and generating hydrogen from the chemical compound from which hydrogen is obtainable by a reforming reaction and/or a hydrocarbon decomposition reaction. Therefore, the method of the present invention allows the production of hydrogen from the raw material that contains the chemical compound which is hardly applicable to the conventional hydrogen manufacturing method which is one obtaining hydrogen using reforming catalysts or one obtaining hydrogen by directly decomposing hydrocarbon.

### BACKGROUND OF THE INVENTION

1. Field of the Invention

The present invention relates to a method and system for manufacturing hydrogen from a raw material that includes a chemical compound from which hydrogen is hardly obtainable by a reforming reaction or a hydrocarbon decomposition reaction.

2. Description of the Related Art

The combustion energy of hydrogen per unit mass is large, so that such an energy can be converted into electric power by means of fuel cell or the like with a high degree of efficiency. In addition, there is a negligible amount of environmental impact at the time of energy conversion with respect to hydrogen. Thus, it becomes considered as an energy medium of the next generation.

Under present circumstances, however, hydrogen is too expensive to be in common use, compared with the other energy media.

In spite of insufficient use of hydrogen as an energy medium at the present, hydrogen is industrially prepared from: the steam reforming of crude oil or primary petroleum products obtained therefrom such as naphtha (hereinafter, collectively referred to as crude oil); the steam reforming of natural gas or the like; the gasification of coal; the electrolysis of water; and so on.

According to the description in the publication of: Klaus Weissermel und Hans-Juergen Arpe, Industrial Organic Chemistry (Second, Revised and Extended Edition), VCH Publishers, Inc., New York, N.Y., U.S.A. (1993) , the primary industrial source of hydrogen is the steam reforming of crude oil that produces almost the half of the gross hydrogen production in the world. Subsequently, the steam reforming of natural gas ranks next and the gasification of coal ranks third. That is, the steam reforming of natural gas produces about 30% and the gasification of coal produces about 15% of the gross hydrogen production, respectively.

Hydrogen prepared by the electrolysis of water occupies just about 3% or less of the gross hydrogen production because of requiring the large amount of electric power. This method is disadvantageous especially when electric power is expensive, so that it would not be performed except in some specific cases such as in a case that surplus power could be obtained.

Alternatively, there are some other methods to prepare hydrogen, which have been proposed in the art, such as the electrolysis of water using a photocatalyst and the decomposition of water using solar heat. However, each of these methods is just under study and is thus not in a stage to practical use.

As described above, presently, the substantial amount of hydrogen to be used in the industries is prepared by the steam reforming of fossil fuel, especially crude oil or natural gas. In any nation where the energy production depends to a large degree on crude oil or natural gas, it is not too much to say that crude oil or natural gas can be provided as a raw material for preparing most of the hydrogen production.

The steam reforming is a method in which hydrocarbon or the like is reacted with water vapor at a high temperature in the presence of appropriate catalyst. For example, in the case of hydrocarbon, the reaction can be proceeded as follows to generate hydrogen.

CₙHₘ+nH₂O→(n+0.5m)H₂+nCO (1)

In general, the reaction is further proceeded as follows to allow the additional generation of hydrogen.

CO+H₂O→H₂+CO₂ (2)

The catalysts for generating the above reactions (1) and (2) have been studied in the art from a long time ago. As disclosed in Japanese Patent Laid-Open Publication No. Sho. 58-163441 (1983), for example, such catalysts include nickel and vanadium oxide which are carried on diatomite.

In recent years, efforts have been put into development of cheaper catalysts or long-life catalysts for the purpose of lowering the catalyst price per unit catalyst reaction. Such catalysts include α-alumina bearing nickel catalyst as disclosed in Japanese Patent Laid-open Publication No 2000-794340, magnesium oxide bearing rhodium and/or ruthenium catalyst disclosed in Japanese Patent Laid-Open Publication No. 2000-44203, and so on.

As stated so far, efforts have been put into technical development to produce hydrogen at a low price in recent years. This is because that expensive hydrogen delays wider use thereof as described above. In spite of such efforts, however, the use of hydrogen has not fully spread as an energy medium in nature. This is because that the raw material used for the generation of hydrogen is crude oil or natural gas.

The prices of crude oil and natural gas have positive correlation with the price of oil as described in, for example, the article entitled as “Rapid increase in the price of oil throws cold water on economic recovery” in Japanese weekly magazine; Diamond, page 14 Oct. 7, 2000. Therefore, the price of hydrogen is also positively correlated with the price of oil. Generally, the phenomenon in which the price of oil is expensive must be the golden opportunity for the widespread of energy media other than crude oil. However, hydrogen cannot be widely spread as the energy media because of its adverse correlation with the prices as described above. On the other hand, if the price of crude oil becomes low, then the price of hydrogen decreases. In such situations, however, the prices of crude oil and natural gas become decrease, so that it is not coupled with the spread of hydrogen.

It is expectable that the correlation with oil price becomes possible to be decreased if any one of secondary or tertiary oil products (e.g., alcohols) having lower price correlation could be used as a raw material, also encouraging broad use of hydrogen.

In addition, if an alcohol-contained waste fluid which can be obtained in various industries and can be got at a low price is used as a raw material, the further cost reduction will also become possible.

From this point of view, studies have been also done on the generation of hydrogen by the reforming reaction of alcohol with the conventional reforming catalyst. Regarding the alcohol having only one carbon (i.e., methanol: CH₃OH), in actual, it has been allowed to obtain hydrogen by the reforming reaction of methanol with a reforming catalyst.

Regarding alcohols with two or more carbons, on the other hand, there is no report in which hydrogen is obtained using the conventional catalyst in the reforming reaction. Moreover, other organic compounds (e.g., esters and amines) are exactly alike.

Alcohols having two or more carbons, especially 2-propanol having three carbons are used on a massive scale for washing in semiconductor industries and after the washing a large amount of 2-propanol is discarded as a waste liquid. Moreover, esters such as ethyl lactate, butyl acetate, and ethyl acetate and amines such as monoethyl amine are also used and discarded as waste liquids on massive scales in various industries, respectively. In the prior art, however, such waste liquids cannot be used as raw materials for the generation of hydrogen.

Ethanol, which is alcohol having two carbons, can be generated in volume by, for example the hydrolytic degradation of plant carbohydrate (e.g., cellulose). If it can be allowed to reforming, the hydrogen preparation from biomass will become possible. In the prior art technology, however, ethanol cannot be used as a raw material for the generation of hydrogen.

There is a lot of uncertainties about the reasons why the alcohols having two or more carbons cannot be reformed using the conventional reforming catalyst. As pieced together from the various bindings which have been obtained in the art up to now, it may be assumed as follows.

The conventional reforming catalyst generates a radical by opening the most weaken bond among the bonds belonging to the molecule of raw material (cracking). The generation of hydrogen may be caused by the sequential reaction of this radical with other molecules. For example, if methane and water are used as raw materials, one of C—H bonds, the most weaken bond in methane is cleaved by the reforming catalyst and then the subsequent reaction steps are occurred as follows.

CH₄→CH₃+H (3)

H₂O+H→H₂+OH (4)

CH₃+H₂O→CH₃OH+H (5)

CH₃+OH→CH₃OH (6)

When CH₃OH is generated by each of the reactions of (5) and (6) O—H or C—H bond in CH₃OH, which are more easily cleaved compared with the C—H bond of methane, is cleaved by the reforming catalyst and then dehydration reactions are sequentially occurred, resulting in the generation of carbon monoxide and hydrogen.

CH₃OH→H₂CO+H₂ (7)

H₂CO→CO+H₂ (8)

As described, therefore, it is possible to generate hydrogen from methanol which is alcohol having one carbon by each of the reactions (2), (7), and (8).

In the case of alcohol having two or more carbons, the reaction corresponding to the above (7) may cause aldehyde having alkyl group or ketone, which is thermodynamically stable. Thus, it is hard to be dehydrogenated, so that the reaction can be discontinued. Especially in the case of secondary alcohol, a dehydration reaction has its kinetic and thermodynamic advantages compared with those of the reforming reaction using water vapor. Thus, the dehydration can be dominantly caused and thus ketone can be directly generated.

CH₃CH(OH)CH₃→CH₃COCH₃+H₂O (9)

CH₃CH(OH)CH₂CH₃→CH₃COCH₂CH₃+H₂O (10)

The resulting ketone is stable, so that it would be difficult to became radical using the conventional reforming catalyst.

For those reasons described above, using the conventional reforming catalyst is not appropriate to prepare hydrogen from alcohol having two or more carbons.

Moreover, amines and esters have the same disadvantages, so that the conventional reforming catalyst is not appropriate to prepare hydrogen from these compounds.

Each of molecules or compounds mentioned above is regarded as in its pure form, so that following additional problems should be considered if organic waste materials generated in various kinds of industries or the like would be used as raw materials.

That is, waste liquids and the like generated from various industries typically contain the compounds useful in the steam reforming in concentrations that vary from place to place. Also, reaction conditions (operation conditions) for the steam reforming reaction are sensitive to shifts in the ratio between the hydrocarbon contained in the raw material and the water vapor additionally provided. Therefore, such waste liquids may belong in the category of being difficult to be used in the steam reforming reaction.

### SUMMARY OF THE INVENTION

It is an object of the present invention to provide a hydrogen manufacturing method and a hydrogen manufacturing system, which allow the production of hydrogen from a raw material that includes a chemical compound which is difficult to be used for generating hydrogen by the conventional hydrogen manufacturing method, i.e., a reforming reaction in which hydrogen is obtained using a reforming catalyst or a hydrocarbon decomposition reaction in which hydrogen is obtained by directly decomposing hydrocarbon.

It is another object of the present invention to provide a hydrogen manufacturing method and a hydrogen manufacturing system, which allow the cheap production of hydrogen from a waste liquid that includes a chemical compound which is difficult to be used for generating hydrogen by the conventional hydrogen manufacturing method.

Therefore, a first aspect of the present invention is a method for manufacturing hydrogen from a raw material that contains a chemical compound from which hydrogen is hardly obtainable and an actual hydrogen yield of which is less than 50% of the stoichiometric yield thereof. Said method according to the first aspect of the present invention comprises the steps of: converting the chemical compound from which hydrogen is hardly obtainable into a chemical compound from which hydrogen is obtainable and an actual hydrogen yield of which is 50% or more of the stoichiometric yield thereof, by a conversion reaction; and generating hydrogen from the chemical compound from which hydrogen is obtainable by a reforming reaction and/or a hydrocarbon decomposition reaction.

Preferably, the chemical compound from which hydrogen is hardly obtainable may be a chemical compound allowing that the actual yield of hydrogen generated from the reforming reaction where carbon monoxide or carbon dioxide and hydrogen are generated from the chemical compound and water vapor under ordinary pressure at 800° C. is less than 50% of the stoichiometric yield of hydrogen.

Preferably, the chemical compound from which hydrogen is hardly obtainable may be a chemical compound allowing that the actual yield of hydrogen generated from a hydrocarbon decomposition reaction where carbon and hydrogen are generated from the chemical compound under ordinary pressure at 500° C. is less than 50% of the stoichiometric yield of hydrogen.

Preferably, the chemical compound from which hydrogen is hardly obtainable may be a chemical compound allowing that an actual yield of hydrogen generated from each of: a reforming reaction where carbon monoxide or carbon dioxide and hydrogen are generated from the chemical compound and water vapor under ordinary pressure at 800° C.; and a hydrocarbon decomposition reaction where carbon and hydrogen are generated from the chemical compound under ordinary pressure at 500° C. is less than 50% of the stoichiometric yield of hydrogen.

Preferably, the chemical compound from which hydrogen is hardly obtainable may be an alcohol having two or more carbons, the chemical compound from which hydrogen may be obtainable is a hydrocarbon, and the reaction for converting the alcohol into the hydrocarbon may be a dehydration reaction.

Preferably, the alcohol may be 2-propanol and the hydrocarbon may be propene.

Preferably, the chemical compound from which hydrogen is hardly obtainable may be an ester having two or more carbons, the chemical compound from which hydrogen is obtainable is a hydrocarbon, and the reaction for converting the alcohol into the hydrocarbon may be a combination of hydrolysis reaction in which the ester is decomposed by the hydrolysis to yield an alcohol and dehydration reaction in which the resulting alcohol is dehydrated and converted into hydrocarbon.

Preferably, the chemical compound for which hydrogen is hardly obtainable may be an amine having one or more carbons, the chemical compound from which hydrogen is obtainable is a hydrocarbon, and the conversion reaction is deammonium reaction in which the amine is converted into the hydrocarbon by deammoniation.

Preferably, a reforming catalyst may be used for the reforming reaction.

Preferably a hydrocarbon decomposition catalyst may be used for the hydrocarbon decomposition reaction.

Preferably, the hydrocarbon decomposition catalyst may be a nickel catalyst.

Preferably, the hydrocarbon decomposition catalyst may be a precious metal catalyst containing at least one precious metal selected from the group consisting of palladium, rhodium, and platinum.

Preferably, a conversion catalyst may be used for the conversion reaction.

Preferably, the conversion catalyst may be at least one selected from the group consisting of alumina catalyst, silica catalyst, zeolite catalyst, alkali-treated zeolite catalyst, alkali-treated alumina catalyst, alkali-treated silica catalyst, alkali-treated silica alumina catalyst, and silica alumina catalyst.

Preferably, the compound from which hydrogen may be hardly obtainable is a compound that forms an azeotropic compound with water, and when water is contained in the raw material, an additive for breaking an azeotropic relation between the chemical compound from which hydrogen is hardly obtainable and water may be added to the raw material and the raw material may be subjected to distillation or fractional distillation to condense the chemical compound from which hydrogen is hardly obtainable, followed by performing the conversion reaction.

Preferably, the additive for breaking the azeotropic relation may be one selected from the group consisting of sodium carbonate, sodium chloride, sodium acetate, potassium chloride, potassium acetate, potassium iodide, calcium chloride, calcium bromide, barium chloride, magnesium chloride, and magnesium bromide.

In a second aspect of the present invention, a system for manufacturing hydrogen from a raw material that contains a chemical compound from which hydrogen is hardly obtainable and an actual hydrogen yield of which is less than 50% of the stoichiometric yield thereof. Said system according to the second aspect of the present invention comprises a converter for converting the chemical compound from which hydrogen is hardly obtainable into a chemical compound from which hydrogen is obtainable and an actual hydrogen yield of which is 50% or more of the stoichiometric yield thereof, by a conversion reaction; and a reactor for generating hydrogen from the chemical compound from which hydrogen is obtainable by a reforming reaction and/or a hydrocarbon decomposition reaction.

Preferably, the chemical compound from which hydrogen is hardly obtainable may be a chemical compound allowing that the actual yield of hydrogen generated from the reforming reaction where carbon monoxide or carbon dioxide and hydrogen are generated from the chemical compound and water vapor under ordinary pressure at 800° C. is less than 50% of the stoichiometric yield of hydrogen.

Preferably, the chemical compound from which hydrogen is hardly obtainable may be a chemical compound allowing that the actual yield of hydrogen generated from a hydrocarbon decomposition reaction where carbon and hydrogen are generated from the chemical compound under ordinary pressure at 500° C. is less than 50% of the stoichiometric yield of hydrogen.

Preferably, the chemical compound from which hydrogen is hardly obtainable may be a chemical compound allowing that an actual yield of hydrogen generated from each of: a reforming reaction where carbon monoxide or carbon dioxide and hydrogen are generated from the chemical compound and water vapor under ordinary pressure at 800° C.; and a hydrocarbon decomposition reaction where carbon and hydrogen are generated from the chemical compound under ordinary pressure at 500° C. is less than 50% of the stoichiometric yield of hydrogen.

Preferably, the chemical compound from which hydrogen is hardly obtainable may be an alcohol having two or more carbons, the chemical compound from which hydrogen may be obtainable is an hydrocarbon, and the converter may be a dehydration device for converting the alcohol into the hydrocarbon by a dehydration reaction.

Preferably, the alcohol way be 2-propanol and the hydrocarbon may be propene.

Preferably, the chemical compound from which hydrogen is hardly obtainable may be an ester having two or more carbons, the chemical compound from which hydrogen is obtainable is a hydrocarbon, and the converter may be a hydrolysis-dehydration device for hydrolyzing the ester to yield alcohol and dehydrating the resulting alcohol to convert it into the hydrocarbon.

Preferably, the chemical compound from which hydrogen is hardly obtainable may be an amine having one or more carbons, the chemical compound from which hydrogen is obtainable is a hydrocarbon, and the converter may be a deammonium device for converting the amine into the hydrocarbon by deammoniation.

Preferably, the reactor may include a reforming catalyst.

Preferably, the reactor may include a hydrocarbon decomposition catalyst.

Preferably, the hydrocarbon decomposition catalyst may be a nickel catalyst.

Preferably, the hydrocarbon decomposition catalyst may be a precious metal catalyst containing at least one precious metal selected from the group consisting of palladium, rhodium, and platinum.

Preferably, a conversion catalyst may be used for the conversion reaction.

Preferably, the conversion catalyst may be at least one selected from the group consisting of alumina catalyst, silica catalyst, zeolite catalyst, alkali-treated zeolite catalyst, alkali-treated alumina catalyst, alkali-treated silica catalyst, alkali-treated silica alumina catalyst, and silica alumina catalyst.

Preferably, the system for manufacturing hydrogen includes adding means for adding an additive for breaking an azeotropic relation between water and the chemical compound from which hydrogen is hardly obtainable, and a condenser for condensing the chemical compound from which hydrogen is hardly obtainable by distillation or fractional distillation of the raw material.

Preferably, the additive for breaking the azeotropic relation may be one selected from the group consisting of sodium carbonate, sodium chloride, sodium acetate, potassium chloride, potassium acetate, potassium iodide, calcium chloride, calcium bromide, barium chloride, magnesium chloride, and magnesium bromide.

### BRIEF DESCRIPTION OF THE DRAWINGS

FIG. 1 is a schematic diagram for illustrating a hydrogen manufacturing system according to one of embodiments of the present invention;

FIG. 2 is a schematic diagram for illustrating a hydrogen manufacturing system according to another embodiment of the present invention; and

FIG. 3 is a schematic diagram for illustrating the converter used in the embodiment of the present invention.

### DETAILED DESCRIPTION OF THE PREFERRED EMBODIMENT

Hereinafter, the present invention will be described in detail with reference to the accompanying drawings.

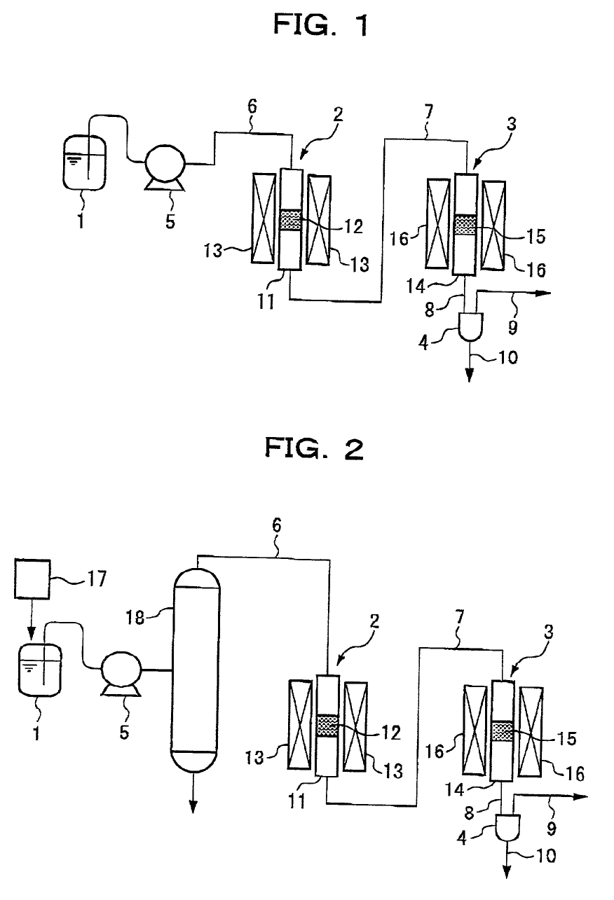

FIG. 1 is a schematic diagram that illustrates a hydrogen manufacturing system as a first embodiment of the present invention. The hydrogen manufacturing system generally includes: a raw material tank 1 for reserving a raw material including a chemical compound from which hydrogen is hardly obtainable; a converter 2 for converting the chemical compound from which hydrogen is hardly obtainable in the raw material into a chemical compound from which hydrogen is obtainable; a reactor 3 for generating hydrogen from the chemical compound from which hydrogen is obtainable by a reforming reaction or a hydrocarbon decomposition reaction; a separator 4 for fractionating a product exhausted from the reactor 3 into gas and liquid; a supply pipe arrangement 6 having one end connected to the raw material tank 1, the other end connected to the converter 2, and a middle portion on which a supply pump 5 is provided; a transport pipe arrangement 7 having one end connected to the converter 2 and the other end connected to the reactor 3; an exhaust pipe arrangement 8 having one end connected to the reactor 3 and the other end connected to the separator 4; an air-discharge pipe 9 for moving the gas obtained from the separator 4 to the next step; and a drain 10 for draining the liquid obtained from the separator 4 to the outside.

Moreover, the converter 2 is generally composed of a converter tower 11, a conversion catalyst 12 placed in the converter tower 11, and a heater 13 for heating the converter tower 11.

The reactor 3 is generally composed of a reactor tower 14, a reaction catalyst 15 placed in the reactor tower 14, and a heater 16 for heating the reactor tower 14.

The method for manufacturing hydrogen using such a hydrogen manufacturing system is as follows.

First, the raw material containing the chemical compound from which hydrogen is hardly obtainable is vaporized in the raw material tank 1 as required, and the vaporized part of the raw material is supplied from the raw material tank 1 to the converter 2 through the supply pump 5. Then, the chemical compound from which hydrogen is hardly obtainable in the raw material is converted into a chemical compound from which hydrogen is obtainable by the conversion reaction using the conversion catalyst 12 in the converter tower 11 while heating by the heater 13 as needed.

Subsequently, the hydrogen-obtainable chemical compound obtained in the converter 2 is transferred to the reactor 3 after separating from unreacted material, by-product material, and side reaction product material as needed, or after the addition of required materials for the next reforming reaction or the hydrocarbon decomposition reaction, or after performing both. In the reactor 3, hydrogen is generated from the chemical compound from which hydrogen is obtainable by the reforming reaction or the hydrocarbon decomposition reaction using the reaction catalyst 15 in the reactor tower 14 with the application of heat by the heater 16 as needed.

Hydrogen generated in the reactor 3 is transferred to the separator 4 together with other products and unreacted materials. Here, it is fractionated into gas containing hydrogen and other materials. The separator 4 may be any one of the devices that allows the increase in the purity of hydrogen or the device that allows the separation of hydrogen from the other materials, such as a cooling trap, a hydrogen separation membrane, a gas separation membrane, gas-liquid separation membrane, or the like, or a combination thereof. In addition, two or more such devices may be connected in tandem.

The “conversion reaction” is a generic term for the reactions by which any chemical compound from which hydrogen is hardly obtainable in the raw material is converted into a chemical compound from which hydrogen is obtainable.

The “raw material” means one including any chemical composed from which hydrogen is hardly obtainable regardless of whether the raw material is in liquid or gas form.

The “chemical compound from which hydrogen is hardly obtainable” is any chemical compound from which hydrogen is not generated in spite of being subjected to the reforming reaction or the hydrocarbon decomposition reaction, or from which the yield of hydrogen is poor and is thus commercially acceptable.

In the hydrogen manufacturing system of the present invention, out of the chemical compounds from which hydrogen is hardly obtainable it is preferable to use any chemical compound having one of the following features (a) to (c).

(a) a chemical compound allowing that the actual yield of hydrogen generated from a reforming reaction where carbon monoxide or carbon dioxide and hydrogen are generated from the chemical compound and water vapor under ordinary pressure at 800° C. is less than 50% of the stoichiometric yield of hydrogen.

(b) a chemical compound allowing that the actual yield of hydrogen generated from a hydrocarbon decomposition reaction where carbon and hydrogen are generated from the chemical compound under ordinary pressure at 500° C. is less than 50% of the stoichiometric yield of hydrogen.

(c) a chemical compound allowing that the actual yield of hydrogen generated from each of a reforming reaction where carbon monoxide or carbon dioxide and hydrogen are generated from the chemical compound and water vapor under ordinary pressure at 800° C. and a hydrocarbon decomposition reaction where carbon and hydrogen are generated from the chemical compound under ordinary pressure at 500° C. is less than 50% of the stoichiometric yield of hydrogen.

It is noted that one of the advantageous features of the hydrogen manufacturing system of the present embodiment is the capability of manufacturing hydrogen from any of the chemical compounds (a) to (c) which are not considered as the chemical compounds to be used for the generation of hydrogen in the prior art.

Concrete examples of such chemical compounds from which hydrogen is hardly obtainable include alcohols having two or more carbons, esters having two or more carbons, and amines having one or more carbons. Here, The term “alcohol” is a generic term for a chemical compound in which at least one of hydrogen atoms of a hydrocarbon molecule is substituted with a hydroxyl group. In addition, the term “ester” is a generic term for a chemical compound in which alcohol and acid are esterified together. In addition, the term “amine” is a generic term for a chemical compound where at least one hydrogen atom of a hydrocarbon molecule is substituted with an amino group.

The alcohols having two or more carbons include, for example, ethanol, 2-propanol, 2-butanol, and 2-methyl-2-propanol.

The esters having two or more carbons include, for example, ethyl lactate, butyl acetate, ethyl acetate, and isopropyl acetate.

The amines having one or more carbons include monoethyl amine, 2-amino propane, 2-amino butane, and 2-methyl-2-amino propane.

These alcohols having two or more carbons, esters having two or more carbons, and amines having one or more carbons are used in large quantity in various industries and many of them are discarded, while they can be obtainable at low prices. Therefore, for manufacturing hydrogen at low prices, the present embodiment utilizes alcohols having two or more carbons, esters having two or more carbons, and amines having one or more carbons.

Among the alcohols having two or more carbons, 2-propanol which is used and discarded in large quantity in semiconductor industry may be applied in the present embodiment to allow the generation of hydrogen at still lower prices.

The “chemical compound from which hydrogen is obtainable” is any of chemical compounds where the actual yield of hydrogen generated from a reforming reaction and/or a hydrocarbon decomposition reaction is less than 50% of the stoichiometric yield of hydrogen when the chemical compound from which hydrogen is hardly obtainable is one of the above chemical compounds (a) to (c). Alternatively, it is any of hydrocarbons when the chemical compound from which hydrogen is hardly obtainable is one selected from alcohols having two or more carbons, esters having two or more carbons, and amines having one or more carbons.

Specifically, the “conversion reaction” is: a dehydration reaction when the compound from which hydrogen is hardly obtainable is alcohol having two or more carbons; a hydrolytic degradation and dehydration reaction when the compound from which hydrogen is hardly obtainable is ester having two or more carbons; or a deammoniation reaction when the compound from which hydrogen is hardly obtainable is ester having two or more carbons.

In the converter 2, that is, alcohol having two or more carbons is converted into hydrocarbon by the dehydration reaction using the conversion catalyst 12. At this time, the converter 2 is functioned as a dehydration device. Also, ester having two or more carbons is converted into hydrocarbon by the steps of: hydrolytic degradation of ester using the conversion catalyst 12 to generate alcohol; and the dehydration of the resulting alcohol using the conversion catalyst 12. At this time, the converter 2 is functioned as a hydrolysis-dehydration device. Here, the hydrolysis and the dehydration may be performed in a single reactor tower, or alternatively they may be independently performed in different reactor towers. In the case of the former, a single catalyst having two different functions or a combination of two different catalysts may be used, or two different catalysts may be arranged in row in the reaction tower. Also, amine having one or more carbons is converted into hydrocarbon by the deammoniation reaction using the conversion catalyst 12. At this time, the converter 2 is functioned as a deammoniation device.

If the chemical compound from which hydrogen is hardly obtainable is 2-propanol, the conversion reaction can be specifically proceeded as follows.

CH₃CH(OH)CH₃→CH₂═CH—CH₃+H₂O (11)

In addition, if the chemical compound from which hydrogen is hardly obtainable is monoethyl amine, the conversion reaction can be specifically proceeded as follows.

CH₃CH₂NH₂→CH₂—CH₂+NH₃ (12)

Moreover, if the chemical compound from which hydrogen is hardly obtainable is ethyl acetate, the conversion reaction can be specifically proceeded as follows.

CH₃COOCH₂CH₃+H₂O→CH₃COOH+CH₃CH₂OH (13)

CH₃CH₂OH→CH₂═CH₂+H₂O (14)

It is preferable to separate hydrocarbon from the mixture containing the hydrocarbon obtained by any of these reactions, prior to subject hydrocarbon to the next reforming reaction or hydrocarbon decomposition reaction, for reducing the adverse effects on the reaction catalyst 15 while increasing the energy efficiency in the reforming reaction or the hydrocarbon decomposition reaction.

The conversion catalyst 12 may be any one of catalysts to be used in typical dehydration, hydrolytic degradation, and deammoniation reactions and so on. Among these conversion catalysts, it is preferably at least one selected from the group consisting of alumina catalyst, silica catalysts zeolite catalyst, alkali-treated zeolite catalyst, alkali-treated alumina catalyst, alkali-treated silica catalyst, alkali-treated silica alumina catalyst, and silica alumina catalyst. These catalysts show excellent converting efficiencies and are cost effective. In addition, each of these catalysts can be applied as a single catalyst in each of the dehydration, hydrolytic degradation, and deammoniation reactions. Therefore, the conversion reaction of ester and the conversion reaction of a mixture including at least two or more of esters and amines may be performed in a single converter, so that the cost for manufacturing hydrogen can be further decreased.

Among those conversion catalysts, furthermore, alkali-treated zeolite catalyst, alkali-treated alumina catalyst, alkali-treated silica catalyst, and alkali-treated silica alumina catalyst are preferable in that they have their respective excellent catalytic properties and/or their respective long catalytic service lives.

Moreover, among the above conversion catalysts, the silica alumina catalyst is preferable in its cost effective, high activity, and excellent adaptability in general purpose. Furthermore, the alkali-treated silica alumina catalyst is preferable in that it has longer catalytic life time in addition to its cost effective, high activity, and excellent adaptability in general purpose. Specifically, the silica alumina catalyst may be silica alumina having the aluminum content of 0.01 to 50%. Here, the term “aluminum content” means a percent value obtained by dividing the sum of the atomic number of aluminum and the atomic number of silicon in the catalyst by the atomic number of aluminum. As the alkali-treated silica alumina catalyst, any of those treated with various alkalines can be used. The way of alkali treatment is not limited to particular one, but for example a method including the steps of dipping the silica alumina catalyst in a sodium hydroxide aqueous solution, followed by washing and drying.

In addition, the alkali-treated zeolite catalyst, alkali-treated alumina catalyst, alkali-treated silica catalyst, or the like can be obtained by the same way.

The reforming reaction is a reaction to obtain carbon monoxide or carbon dioxide and hydrogen by reacting the chemical compound from which hydrogen is obtainable with water vapor. Typically, the reforming reaction is performed under a pressure of 1×10³ to 1×10⁷ pascals at a temperature of 100 to 1200° C.

Concrete examples of the chemical compound from which hydrogen is obtainable may be hydrocarbons. The hydrocarbons to be obtained by the above conversion reaction include ethylene, propene, 2-butene, 2-methyl propene.

The reaction catalyst 15 to be used in the reforming reaction (i.e., the reforming catalyst) may include those of well known in the art, for example α-alumina-bearing nickel catalyst, magnesium oxide bearing rhodium, and/or ruthenium catalyst, α-alumina bearing cobalt catalyst, α-alumina bearing nickel-cobalt catalyst, and α-alumina bearing iron nickel catalyst.

The hydrocarbon decomposition reaction is a reaction to obtain a chemical compound from which hydrogen is obtainable, i.e., hydrogen and carbon are obtained from hydrocarbon. Typically, the hydrocarbon decomposition reaction is performed under a pressure of 1 to 1×10⁷ pascals at a temperature of 100 to 1000° C.

Specifically, the hydrocarbon decomposition reaction proceeds as follows.

CₙHₘ→nC+0.5mH₂ (15)

The reaction catalyst used in the hydrocarbon decomposition reaction (i.e., hydrocarbon decomposition catalyst) may be one of those well known in the art Among them, with respect to high activity and excellent flexibility, nickel catalyst; or precious metal catalyst containing one precious metal selected from the group consisting of palladium, rhodium, and platinum may preferably be used.

The nickel catalyst may be, specifically, one having a nickel bearing content of 0.01 to 3%. Also, the precious metal catalyst may be, specifically, one having a palladium, rhodium, or platinum bearing content of 0.01 to 3%. Furthermore, the precious metal catalyst may be one having a total precious metal bearing content of 0.1 to 10%.

Here, the term “bearing content” means the mole bearing amount of nickel, palladium, or platinum with respect to a carrier, while “a total precious metal bearing content” means a sum of each mole bearing amount of palladium, rhodium, and platinum.

In such a hydrogen manufacturing method, the chemical compound from which hydrogen is hardly obtainable in the raw material is converted into a chemical compound from which hydrogen can be manufactured by the conversion reaction, followed by generating hydrogen from the chemical compound from which hydrogen can be manufactured by the reforming reaction and/or hydrocarbon decomposition reaction. Thus, it is possible to obtain hydrogen from the raw material which contains a chemical compound difficult to be applied in the system of generating hydrogen by directly decomposing hydrocarbon or the system of generating hydrogen using the conventional reforming catalyst.

In the hydrogen manufacturing method of the preset embodiment, the conversion reaction, the reforming reaction, and the hydrocarbon decomposition reaction use the conversion catalyst, the reforming catalyst, and the hydrocarbon decomposition catalyst, respectively. According to the present invention, however, it is not limited to apply individual catalysts on the conversion reaction, the reforming reaction, and the hydrocarbon decomposition reaction, respectively. In view of the excellent conversion efficiency in the conversion reaction and the excellent reaction efficiency in the reforming reaction or hydrocarbon decomposition reaction, it is preferable to use individual catalysts for the respective reactions.

Such a hydrogen manufacturing system, furthermore, includes a converter 2 for converting a chemical compound from which hydrogen is hardly obtainable in a raw material into a chemical compound from which hydrogen is obtainable by conversion reaction, and a reactor 3 for manufacturing hydrogen from the chemical compound from which hydrogen is obtainable by reforming reaction or hydrocarbon decomposition reaction. Therefore, it is possible to obtain hydrogen from the raw material that contains the chemical compound difficult to be applied in the system of generating hydrogen by directly decomposing hydrocarbon or the system of generating hydrogen using the conventional reforming catalyst.

In the hydrogen manufacturing system of the preset embodiment, conversion catalyst 12 and reaction catalyst 15 are arranged in the converter 2 and the reactor 3, respectively. The hydrogen manufacturing system according to the present invention, however, may not be limited to the present embodiment if the conversion reaction can be performed in the converter, while the reforming reaction or the hydrocarbon decomposition reaction can be performed in the reactor. It is also possible to provide a catalyst on either the converter or the reactor or to provide no catalyst on both the converter and the reactor. In view of the excellent conversion efficiency in the converter and the excellent reaction efficiency in the reactor, it is preferable to use the conversion catalyst and the reaction catalyst in the converter and the reactor, respectively.

In the hydrogen manufacturing system of the present embodiment, there are one converter 2 and one reactor 3. According to the present invention, however, the number of each of them is not limited to the specified one. It is also possible to provide two or more converters and/or two or more reactors, respectively.

Moreover, in the hydrogen manufacture system of the present embodiment, the conversion reaction and the reforming reaction, or the hydrocarbon decomposition reaction is performed continuously. However, the reactor 3 may be omitted, while reserving means may be provided instead thereof so as to once store the chemical compound from which hydrogen can be manufactured. By preparing such reserving means, only by substituting a reaction catalyst with the conversion catalyst, it becomes possible to use the converter also as a reactor, so that a hydrogen manufacturing system can be simplified.

FIG. 2 is a schematic diagram that illustrates a hydrogen manufacturing system as a second embodiment of the present invention. The hydrogen manufacturing system of the present embodiment is the same as that of the first embodiment except that it further includes adding means 17 for adding an additive into the raw material stored in the raw material tank 1 and a condenser 18 for condensing a chemical compound from which hydrogen is hardly obtainable in the raw material by performing the distillation or the fractional distillation on the raw material. Such an additive breaks the azeotropic relation between the chemical compound from which hydrogen is hardly obtainable and water.

Such a hydrogen manufacturing system may be used in the hydrogen manufacturing method in which hydrogen is manufactured from a raw material which is a chemical compound that forms an azeotropic compound between the chemical compound from which hydrogen is hardly obtainable and water and that contains water therein.

The hydrogen manufacturing method using the above hydrogen manufacturing system is as follows.

First, the additive for breaking the azeotropic relation between the chemical compound from which hydrogen is hardly obtainable and water is added into the raw material stored in the raw material tank 1. The raw material is subjected to distillation or factional distillation in the condenser 18, so that the chemical compound from which hydrogen is hardly obtainable is condensed.

Next, the raw material which contains the condensed chemical compound from which hydrogen is hardly obtainable is supplied to the converter 2. The chemical compound from which hydrogen is hardly obtainable in the raw material is heated by the heater 13 as needed, while converting the chemical compound into a chemical compound from which hydrogen is obtainable by the conversion reaction using the conversion catalyst 12 in the conversion tower 11.

Subsequently, the chemical compound from which hydrogen can be manufactured obtained by the converter 2 is transferred to the reactor 3. In the reactor 3, hydrogen is manufactured from the hydrogen-obtainable compound by the reforming reaction or the hydrocarbon decomposition reaction using the reaction catalyst 15 in the reaction tower 14, while heating by the heater 16 as needed.

In this embodiment, the removal of unreacted reaction materials and by-product materials to be caused by the reaction or the need of adding the materials to be required in the reaction are similar to as in the first embodiment.

The term “azeotropic mixture” means a mixture of the chemical compound from which hydrogen is hardly obtainable and water, where the solution composition and the vapor composition are corresponded to each other under the external pressure in the process which makes the mixture evaporate.

Concrete examples of the chemical compound from which hydrogen is hardly obtainable while forms an azeotropic mixture with water my include alcohols having two or more carbons, esters having two or more carbons, and amines having one or more carbons.

Concrete examples of the raw material including the chemical compound from which hydrogen is hardly obtainable and which forms an azeotropic mixture with water and water may include an aqueous solution of alcohols having two or more carbons, an aqueous solution containing esters having two or more carbons, an aqueous solution of amines having one or more carbons, waste liquids containing organic solvent and water generated from various industries, more specifically waste liquids containing 2-propanol and water generated in semiconductor industries.

The above additives may be of breaking the azeotropic relation between water and the chemical compound from which hydrogen is hardly obtainable, so that they are not specifically confined. Among them, it is preferable at least one selected from the group of sodium carbonate, sodium chloride, sodium acetate, potassium chloride, potassium acetate, potassium iodide, calcium chloride, calcium bromide, barium chloride, magnesium chloride, and magnesium bromide because of their cost effectiveness and high flexibilities.

In such a hydrogen manufacturing method, the additive for breaking the azeotropic relation between the chemical compound from which hydrogen is hardly obtainable and water is added into the raw material. Then, the raw material is subjected to distillation or fractional distillation, and subsequently the chemical compound from which hydrogen is hardly obtainable is condensed, followed by performing the above conversion reaction. Therefore, it becomes possible to obtain hydrogen from the waste liquid that contains the chemical compound from which hydrogen is hardly obtainable. In addition, hydrogen is obtained from the waste liquid, so that the resulting hydrogen can be less expensive.

Such a hydrogen manufacturing system includes adding means for adding an additive for breaking the azeotropic relation between the chemical compound from which hydrogen is hardly obtainable and water, and a condenser for condensing the chemical compound from which hydrogen is hardly obtainable by subjecting the raw material to distillation or fractional distillation. Therefore, it becomes possible to obtain hydrogen from the waste liquid that contains the chemical compound from which hydrogen is hardly obtainable. In addition, hydrogen is obtained from the waste liquid, so that the resulting hydrogen will become less expensive.

Moreover, the impurities which may have adverse effects on the catalysts or the devices used in the conversion reaction, the reforming reaction, or the hydrocarbon decomposition reaction, and the impurities (water etc.) which may cause the decrease in energy efficiency can be removed.

If water is especially contained as purities, it will be required to not only simply lower the energy efficiency but also remove water as much as possible because the caulking (carbon deposition reaction) becomes easy to occur. Here, the term “caulking” is a sub-reaction that produces the undesired phenomenon of degrading the catalyst used in the reforming reaction.

In addition, even if the additive is not added, water may be removed by the simple distillation, fractional distillation, or the like if it allows the removal of water.

Moreover, the addition of additive and the concentration of raw material do not affect on the catalysts and the devices used in the conversion reaction, the reforming reaction, or the hydrocarbon decomposition reaction, while increasing the energy efficiency. Therefore, if there is no problem to be caused, the addition of additive and the concentration of raw material can be omitted.

Hereinafter, we will concretely describe the present invention by way of examples.

### EXAMPLE 1

Conversion Reaction of 2-Propanol

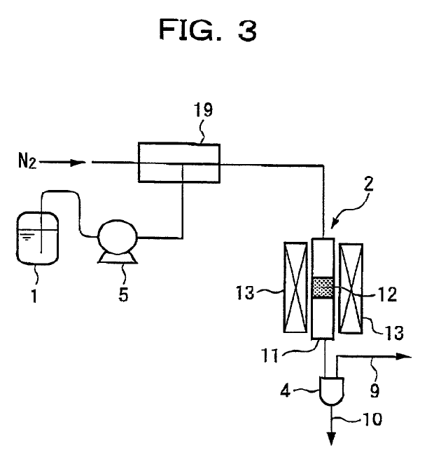

A system having a raw material tank 1, a vaporizer 19, a converter 2, and a cooling trap 4 as shown in FIG. 3 was used to covert 2-propanol into propene at first. The system is available as “Compact Flow” from Okura Riken Co., Ltd., JAPAN.

2-propanol (99.9% or more purity, available from Tokuyama Co., Ltd.) was supplied from the raw material tank 1 at a speed of 0.23 cm³/min to the vaporizer 19 by which 2-propanol was vaporized at 180° C., followed by diluting with nitrogen (99.9999% or more of purity) to provide a total flow of 500 cm³/min (flow of standard state conversion). Subsequently, the raw material gas was passed through a conversion catalyst 12 in the converter 2 under atmospheric pressure at 300° C. Here, as the conversion catalyst 12, a silica alumina catalyst (the content of alumina: approximately 13%, BET specific surface area of about 430 m²/g) was used. The main reaction was dehydration reaction of 2-propanol. The yield of propene was about 93%.

CH₃CH(OH)CH₂→CH₂═CH—CH₃+H₂O (11)

Reforming Reaction of Propene

The gas including the obtained propene was mixed with water vapor at a volume ratio of 1:8 (gas:water vapor). The mixed gas was passed through a nickel catalyst (i.e., nickel bearing alumina catalyst, a nickel-bearing ratio of 0.5%, a BET specific surface area of approximately 40 m²/g) with a mixed gas flow of 100 cm²/minute under atmospheric pressure at a reaction temperature of 800° C. The main reaction was the steam reforming reaction of propene, where the reaction ratio of propene was about 96% and the actual yield of hydrogen corresponded about 91% of the theoretical yield.

### EXAMPLE 2

Conversion Reaction of 2-Propanol

The conversion reaction of 2-propanol was performed similarly to the Example 1 except for the catalyst. In this example, the catalyst was an aluminum catalyst (an aluminum content of about 94% or more, a BET specific surface area of about 200 m²/g). The main reaction was the dehydration reaction of 2-propanol, where the yield of propene was about 98%.

Reforming Reaction of Propene

The gas including the obtained propene was mixed with water vapor at a volume ratio of 1:8 (gas:water vapor). The reforming reaction was performed by passing the mixed gas through a nickel catalyst (i.e., a nickel bearing alumina catalyst, a nickel-bearing ratio of 0.5%, a BET specific surface area of approximately 40 m²/g) with a mixed gas flow of 100 cm³/minute under atmospheric pressure at a reaction temperature of 800° C. The reaction ratio of propene was about 96% and the actual yield of hydrogen corresponded about 96% of the theoretical yield.

### EXAMPLE 3

Alkali-Treated Silica Alumina Catalyst

A silica alumina catalyst was immersed in an aqueous solution of 1 weight % sodium hydroxide for 4 hours with sufficient stirring and then drained. Subsequently, the catalyst was repeatedly rinsed with water until the pH of supernatant became 10.5 or less. Then, the rinsed catalyst was air-dried for 24 hours, and sintered for 2 hours at 400° C., resulting in alkali-treated silica alumina catalyst.

Conversion Reaction of 2-Propanol

The conversion reaction of 2-propanol was performed similarly to the Example 1 except for the catalyst. In this example, the catalyst was the alkali-treated silica alumina catalyst (an aluminum content of about 13%, a BET specific surface area of about 430 m²/g). The main reaction was the dehydration reaction of 2-propanol, where the yield of propene was about 98%.

The catalyst obtained by such a reaction had been continuously used for six months. In spite of such long continuous use, no deterioration of the properties of catalyst was found.

Reforming Reaction of Propene

The gas including the obtained propene was mixed with water vapor at a volume ratio of 1:8 (gas:water vapor). The reforming reaction was performed by passing the mixed gas through a nickel catalyst (i.e., a nickel bearing alumina catalyst, a nickel-bearing ratio of 0.5%, a BET specific surface area of approximately 40 m²/g) with a mixed gas flow of 100 cm²/minute under atmospheric pressure at a reaction temperature of 800° C. The reaction ratio of propene was about 96% and the actual yield of hydrogen corresponded about 94% of the theoretical yield.

### EXAMPLE 4

Decomposition Reaction of Propene

The hydrocarbon decomposition reaction was performed by passing the gas that contains propene obtained in Example 1 through a precious metal catalyst (i.e. a palladium rhodium bearing alumina catalyst, a palladium-bearing ratio of 0.4%, a rhodium-bearing ratio of 0.1%, a BET specific surface area of approximately 160 m²/g) with a space velocity of 3000 h⁻¹ under atmospheric pressure at a reaction temperature of 220° C. The reaction ratio of propene was about 94% and the actual yield of hydrogen corresponded about 90% of the theoretical yield.

### EXAMPLE 5

Decomposition Reaction of Propene

The hydrocarbon decomposition reaction was performed by passing the gas that contains propene obtained in Example 2 through a precious metal catalyst (i.e., a palladium rhodium bearing alumina catalyst, a palladium-bearing ratio of 0.4%, a rhodium-bearing ratio of 0.1%, a BET specific surface area of approximately 160 m²/g) with a space velocity of 3000 h⁻¹ under atmospheric pressure at a reaction temperature of 220° C. The reaction ratio of propene was about 94% and the actual yield of hydrogen corresponded about 92% of the theoretical yield.

### EXAMPLE 6

Decomposition Reaction of Propene

The hydrocarbon decomposition reaction was performed by passing the gas that contains propene obtained in Example 3 through a precious metal catalyst (i.e., a palladium rhodium bearing alumina catalyst, a palladium-bearing ratio of 0.4%, a rhodium-bearing ratio of 0.1%, a BET specific surface area of approximately 160 m²/g) with a space velocity of 3000 h⁻¹ under atmospheric pressure at a reaction temperature of 220° C. The reaction ratio of propene was about 94% and the actual yield of hydrogen corresponded about 92% of the theoretical yield.

### Comparative Example 1

Reforming Reaction of 2-Propanol

2-propanol (available from Tokuyama Co., Ltd., 99.9% or more purity) was vaporized at 180° C. and then mixed with water vapor at a volume ratio of 1:8 (2-propanol:water vapor). Subsequently, the reforming reaction of 2-propanol was performed by passing the mixed gas through a nickel catalyst (i.e., a nickel bearing alumina catalyst, a nickel-bearing ratio of 0.5%, and a BET specific surface area of approximately 40 m²/g) with a flow rate of 100 cm³/minute under atmospheric pressure at a reaction temperature of 800° C. However, we could scarcely obtain hydrogen.

### Comparative Example 2

Decomposition Reaction of 2-Propanol

2-propanol (available from Tokuyama Co., Ltd., 99.9% or more purity) was vaporized and then the hydrocarbon decomposition reaction was performed by passing through a precious metal catalyst (i.e., a palladium rhodium bearing alumina catalyst, a palladium-bearing ratio of 0.4%, a rhodium-bearing ratio of 0.1%, a BET specific surface area of approximately 160 m²/g) with a space velocity of 3000 h⁻¹ and a flow of 100 cm³/minute under atmospheric pressure at a reaction temperature of 220° C. However, there was no hydrocarbon decomposition reaction observed.

From the above examples and comparative examples, the present invention allows the production of hydrogen from 2-propanol while the conventional hydrogen manufacturing method is impossible to obtain hydrogen therefrom.

### EXAMPLE 7

Concentration of 2-Propanol

In a 2-propanol waste liquid that contains 65% of water (mol fraction), calcium chloride was added so as to be adjusted to a mol concentration of 5 mol/l. Then, the 2-propanol waste liquid was distilled. As a result, the concentration of 2-propanol in the fraction was about 96%.

Conversion Reaction of 2-Propanol

The conversion reaction of 2-propanol was performed by the same way as that of Example 1 except that the obtained fraction was used instead of 2-propanol (available from Tokuyama Co., Ltd., 99.9% or more purity). The main reaction was the dehydration reaction of 2-propanol and the yield of propene was about 96%.

Reforming Reaction of Propene

The gas that contains the obtained propene was mixed with water vapor at a volume ratio of 1:8 (gas:water vapor). Subsequently, the reforming reaction was performed by passing the mixed gas through a nickel catalyst (i.e., a nickel bearing alumina catalyst, a nickel-bearing ratio of 0.5%, a BET specific surface area of approximately 40 m²/g) with a mixed gas flow of 100 cm²/minute under atmospheric pressure at a reaction temperature of 800° C. The main reaction was the steam reforming reaction of propene, where the reaction ratio of propene was about 96% and the actual yield of hydrogen corresponded about 91% of the theoretical yield.

### EXAMPLE 8

Conversion Reaction of 2-Propanol

The conversion reaction of 2-propanol was performed by the same way as that of Example 2 except that the fraction obtained in Example 7 was used instead of 2-propanol (available from Tokuyama Co., Ltd., 99.9% or more purity). The main reaction was the dehydration reaction of 2-propanol and the yield of propene was about 98%.

Reforming Reaction of Propene

The gas that contains the obtained propene was mixed with water vapor at a volume ratio of 1:8 (gas:water vapor). Subsequently, the reforming reaction was performed by passing the mixed gas through a nickel catalyst (i.e., a nickel bearing alumina catalyst, a nickel-bearing ratio of 0.5%, a BET specific surface area of approximately 40 m²/g) with a mixed gas flow of 100 cm³/minute under atmospheric pressure at a reaction temperature of 800° C. The reaction ratio of propene was about 96% and the actual yield of hydrogen corresponded about 93% of the theoretical yield.

### EXAMPLE 9

Decomposition Reaction of Propene

The hydrocarbon decomposition reaction was performed by passing the gas that contains propene obtained in Example 7 through a precious metal catalyst (i.e., a palladium rhodium bearing alumina catalyst, a palladium-bearing ratio of 0.4%, a rhodium-bearing ratio of 0.1%, a BET specific surface area of approximately 160 m²/g) with a space velocity of 3000 h⁻¹ and a flow rate of 100 cm³/minute under atmospheric pressure at a reaction temperature of 220° C. The reaction ratio of propene was about 94% and the actual yield of hydrogen corresponded about 90% of the theoretical yield.

### EXAMPLE 10

Decomposition Reaction of Propene

The hydrocarbon decomposition reaction was performed by passing the gas that contains propene obtained in Example 8 through a precious metal catalyst (i.e., a palladium rhodium bearing alumina catalyst, a palladium-bearing ratio of 0.4%, a rhodium-bearing ratio of 0.1%, a BET specific surface area of approximately 160 m²/g) with a space velocity of 3000 h⁻¹ and a flow rate of 100 cm³/minute under atmospheric pressure at a reaction temperature of 220° C. The reaction ratio or propene was about 94% and the actual yield of hydrogen corresponded about 92% of the theoretical yield.

As is evident from the above examples, the present invention allows the production of hydrogen from the 2-propanol waste liquid while the conventional hydrogen manufacturing method is impossible to utilize such a waste liquid as a raw material.

As described above, the hydrogen manufacturing method of the present invention is a method that allows the production of hydrogen by converting the chemical compound from which hydrogen is hardly obtainable in the raw material into the chemical compound from which hydrogen is obtainable and by generating hydrogen from the chemical compound from which hydrogen is obtainable by the reforming reaction and/or the hydrocarbon decomposition reaction. Therefore, the present invention allows the manufacturing of hydrogen from the chemical compound from which hydrogen is hardly obtainable.

In addition, if the chemical compound from which hydrogen is hardly obtainable is an alcohol having two or more carbons, an ester having two or more carbons, or an amine having one or more carbons, a raw material can be obtained at comparatively low price. Thus, hydrogen can be prepared by cheap way. Also, each of the alcohol having two or more carbons, the ester having two or more carbons, and the amine having one or more carbons is hardly influenced by oil price, so that it allows the supply of hydrogen at stable low price.

Especially, if the chemical compound from which hydrogen is hardly obtainable is 2-propanol, hydrogen can be provided at still lower stable price.

In addition, if the reforming catalyst is used in the reforming reaction, the reaction efficiency of reforming reaction can be improved and thus hydrogen can be provided at still lower price.

If the hydrocarbon decomposition catalyst is used in the hydrocarbon decomposition reaction, the reaction efficiency of hydrocarbon decomposition reaction can be improved and thus the reaction can be proceeded at low temperature, allowing the production of hydrogen at still lower price.

If the nickel catalyst is used as the hydrocarbon decomposition catalyst, the production of hydrogen can be performed with high efficiency at low price.

If the hydrocarbon decomposition catalyst is the precious metal catalyst that contains at least one precious metal selected from the group consisting of palladium, rhodium, and platinum, the production of hydrogen can be performed with high efficiency at low price.

If the conversion catalyst is used in the conversion reaction, the conversion efficiency of conversion reaction can be increased and thus such a reaction can be proceeded at low temperature, allowing the production of hydrogen at still lower price.

If the conversion catalyst is one selected from the group consisting of alumina catalyst, silica catalyst, zeolite catalyst, alkali-treated zeolite catalyst, alkali-treated alumina catalyst, alkali-treated silica catalyst, alkali-treated silica alumina catalyst, and silica alumina catalyst, the conversion efficiency of conversion reaction can be further improved, allowing the production of hydrogen at still lower price.

Furthermore, it is possible to cheaply obtain hydrogen from a raw material such as a waste liquid that contains a chemical compound from which hydrogen is hardly obtainable and water, when the conversion reaction is performed after adding an additive for breaking the azeotropic reaction between the chemical compound from which hydrogen is obtainable and water, performing distillation or fractional distillation on the raw material, and condensing the chemical compound from which hydrogen is hardly obtainable.

If the additive that breaks the above azeotropic relation is at least one selected from the group of sodium carbonate, sodium chloride, sodium acetate, potassium chloride, potassium acetate, potassium iodide, calcium chloride, calcium bromide, barium chloride, magnesium chloride, and magnesium bromide, the raw material can be highly condensed, allowing the production of hydrogen at still lower price.

Moreover, the hydrogen manufacturing system of the present invention includes a converter for converting a chemical compound from which hydrogen is hardly obtainable in the raw material into a chemical compound from which hydrogen is obtainable by conversion reaction; and preparing hydrogen from the chemical compound from which hydrogen is obtainable by conversion reaction; and a reactor for preparing hydrogen from the chemical compound from which hydrogen is obtainable by reforming reaction or hydrocarbon decomposition reaction. Therefore, hydrogen can be obtained from a chemical compound from which hydrogen is hardly obtainable.

Still furthermore, the hydrogen manufacturing system of the present invention includes adding means for adding an additive for breaking the azeotropic relation between water and a chemical compound from which hydrogen is obtainable into a raw material, and a condenser for condensing the chemical compound from which hydrogen is hardly obtainable in the raw material. Therefore, hydrogen can be obtained from a raw material such as a waste liquid that contains the chemical compound from which hydrogen is hardly obtainable and water at low price.

What is claimed is:

1. A method for manufacturing hydrogen from a raw material that contains a chemical compound from which hydrogen is hardly obtainable and an actual hydrogen yield of which is less than 50% of the stoichiometric yield thereof, comprising the steps of:
converting said chemical compound from which hydrogen is hardly obtainable into a chemical compound from which hydrogen is obtainable and an actual hydrogen yield of which is 50% or more of the stoichiometric yield thereof, by a conversion reaction; and
generating hydrogen from the chemical compound from which hydrogen is obtainable by a reforming reaction and/or a hydrocarbon decomposition reaction.

2. The method for manufacturing hydrogen according to claim 1, wherein
the chemical compound from which hydrogen is hardly obtainable is a chemical compound allowing that an actual yield of hydrogen generated from a reforming reaction where carbon monoxide or carbon dioxide and hydrogen are generated from the chemical compound and water vapor under ordinary pressure at 800° C. is less than 50% of the stoichiometric yield of hydrogen.

3. The method for manufacturing hydrogen according to claim 1, wherein
the chemical compound from which hydrogen is hardly obtainable is a chemical compound allowing that an actual yield or hydrogen generated from a hydrocarbon decomposition reaction where carbon and hydrogen are generated from the chemical compound under ordinary pressure at 500° C. is less than 50% of the stoichiometric yield of hydrogen.

4. The method for manufacturing hydrogen according to clam 1, wherein
the chemical compound from which hydrogen is hardly obtainable is a chemical compound allowing that an actual yield of hydrogen generated from each of a reforming reaction where carbon monoxide or carbon dioxide and hydrogen are generated from the chemical compound and water vapor under ordinary pressure at 800° C. and a hydrocarbon decomposition reaction where carbon and hydrogen are generated from the chemical compound under ordinary pressure at 500° C. is less than 50% of the stoichiometric yield of hydrogen.

5. The method for manufacturing hydrogen according to claim 1, wherein
the chemical compound from which hydrogen is hardly obtainable is an alcohol having two or more carbons, the chemical compound from which hydrogen is obtainable is a hydrocarbon, and the reaction for converting the alcohol into the hydrocarbon is a dehydration reaction.

6. The method for manufacturing hydrogen according to claim 5, wherein
the alcohol is 2-propanol and the hydrocarbon is propene.

7. The method for manufacturing hydrogen according to claim 1, wherein
the chemical compound from which hydrogen is hardly obtainable is an ester having two or more carbons, the chemical compound from which hydrogen is obtainable is a hydrocarbon, and the reaction for converting alcohol into hydrocarbon is a combination of hydrolysis reaction in which the ester is decomposed by the hydrolysis to yield alcohol and dehydration reaction in which the resulting alcohol is dehydrated and converted into the hydrocarbon.

8. The method for manufacturing hydrogen according to clam 1, wherein
the chemical compound from which hydrogen is hardly obtainable is an amine having one or more carbons, the chemical compound from which hydrogen is obtainable is hydrocarbon, and the conversion reaction is deammonium reaction in which the amine is converted into the hydrocarbon by deammoniation.

9. The method for manufacturing hydrogen according to claim 2, wherein
a reforming catalyst is used for the reforming reaction.

10. The method for manufacturing hydrogen according to claim 4, wherein
a reforming catalyst is used for the reforming reaction.

11. The method for manufacturing hydrogen according to claim 3, wherein
a hydrocarbon decomposition catalyst is used for the hydrocarbon decomposition reaction.

12. The method for manufacturing hydrogen according to claim 4, wherein
a hydrocarbon decomposition catalyst is used for the hydrocarbon decomposition reaction.

13. The method for manufacturing hydrogen according to claim 1, wherein
the hydrocarbon decomposition catalyst is a nickel catalyst.

14. The method for manufacturing hydrogen according to claim 11, wherein
the hydrocarbon decomposition catalyst is a precious metal catalyst containing at least one precious metal selected from the group consisting of palladium, rhodium, and platinum.

15. The method for manufacturing hydrogen according to claim 12, wherein
the hydrocarbon decomposition catalyst is a precious metal catalyst containing at least one precious metal selected from the group consisting of palladium, rhodium, and platinum.

16. The method for manufacturing hydrogen according to claim 1, wherein
a conversion catalyst is used for the conversion reaction.

17. The method for manufacturing hydrogen according to claim 1, wherein
the conversion catalyst is at least one selected from the group consisting of alumina catalyst, silica catalyst, zeolite catalyst, alkali-treated zeolite catalyst, alkali-treated alumina catalyst, alkali-treated silica catalyst, alkali-treated silica alumina catalyst, and silica alumina catalyst.

18. The method for manufacturing hydrogen according to claim 1, wherein
the chemical compound from which hydrogen is hardly obtainable is a chemical compound that forms an azeotropic compound with water, and when water is contained in the raw material, an additive for breaking an azeotropic relation between the chemical compound from which hydrogen is hardly obtainable and water is added to the raw material and the raw material is subjected to distillation or fractional distillation to condense the chemical compound from which hydrogen is hardly obtainable, followed by performing the conversion reaction.

19. The method for manufacturing hydrogen according to claim 1, wherein
the additive for breaking the azeotropic relation is one selected from the group consisting of sodium carbonate, sodium chloride, sodium acetate, potassium chloride, potassium acetate, potassium iodide, calcium chloride, calcium bromide, barium chloride, magnesium chloride, and magnesium bromide.

20. A system for manufacturing hydrogen from a raw material that contains a chemical compound from which hydrogen is hardly obtainable and an actual hydrogen yield of which is less than 50% of the stoichiometric yield thereof, comprising:
a converter for converting the chemical compound from which hydrogen is hardly obtainable into a chemical compound from which hydrogen is obtainable and an actual hydrogen yield of which is less than 50% of the stoichiometric yield thereof, by a conversion reaction; and
a reactor for generating hydrogen from the chemical compound from which hydrogen is obtainable by a reforming reaction and/or a hydrocarbon decomposition reaction.

21. The system for manufacturing hydrogen according to claim 20, wherein
the chemical compound from which hydrogen is hardly obtainable is a chemical compound allowing that an actual yield of hydrogen generated from a reforming reaction where carbon monoxide or carbon dioxide and hydrogen are generated from the chemical compound and water vapor under ordinary pressure at 800° C. is less than 50% of the stoichiometric yield of hydrogen.

22. The system for manufacturing hydrogen according to claim 20, wherein
the chemical compound from which hydrogen is hardly obtainable is a chemical compound allowing that an actual yield of hydrogen generated from a hydrocarbon decomposition reaction where carbon and hydrogen are generated from the chemical compound under ordinary pressure at 500° C. is less than 50% of the stoichiometric yield of hydrogen.

23. The system for manufacturing hydrogen according to claim 20, wherein
the chemical compound from which hydrogen is hardly obtainable is a chemical compound allowing that an actual yield of hydrogen generated from each of a reforming reaction where carbon monoxide or carbon dioxide and hydrogen are generated from the chemical compound and water vapor under ordinary pressure at 800° C. and a hydrocarbon decomposition reaction where carbon and hydrogen are generated from the chemical compound under ordinary pressure at 500° C. is less than 50% of the stoichiometric yield of hydrogen.

24. The system for manufacturing hydrogen according to claim 20, wherein
the chemical compound from which hydrogen is hardly obtainable is an alcohol having two or more carbons, the chemical compound from which hydrogen is obtainable is a hydrocarbon, and the converter is a dehydrogenation device for converting the alcohol into the hydrocarbon by a dehydration reaction.

25. The system for manufacturing hydrogen according to claim 20, wherein
the alcohol is 2-propanol and the hydrocarbon is propene.

26. The system for manufacturing hydrogen according to claim 20, wherein
the chemical compound from which hydrogen is hardly obtainable is an ester having two or more carbons, the chemical compound from which hydrogen is obtainable is a hydrocarbon, and the converter may be a hydrolysis-dehydration device for hydrolyzing the ester to yield alcohol and dehydrating the resulting alcohol to convert it into the hydrocarbon.

27. The system for manufacturing hydrogen according to claim 20, wherein
the chemical compound from which hydrogen is hardly obtainable is an amine having one or more carbons, the chemical compound from which hydrogen is obtainable is a hydrocarbon, and the converter is a deammonium device for converting the amine into the hydrocarbon by deammoniation.

28. The system for manufacturing hydrogen according to claim 20, wherein
the reactor comprises a reforming catalyst.

29. The system for manufacturing hydrogen according to claim 20, wherein
the reactor comprises a hydrocarbon decomposition catalyst.

30. The system for manufacturing hydrogen according to claim 29, wherein
the hydrocarbon decomposition catalyst is a nickel catalyst.

31. The system for manufacturing hydrogen according to claim 29, wherein
the hydrocarbon decomposition catalyst is a precious metal catalyst containing at least one precious metal selected from the group consisting of palladium, rhodium, and platinum.

32. The system for manufacturing hydrogen according to claim 20, wherein
a conversion catalyst is used for the conversion reaction.

33. The system for manufacturing hydrogen according to claim 32, wherein
the conversion catalyst is at least one selected from the group consisting of alumina catalyst, silica catalyst, zeolite catalyst, alkali-treated zeolite catalyst, alkali-treated alumina catalyst, alkali-treated silica catalyst, alkali-treated silica alumina catalyst, and silica alumina catalyst.

34. The system for manufacturing hydrogen according to claim 20, comprising:
adding means for adding an additive for breaking an azeotropic relation between water and the chemical compound from which hydrogen is hardly obtainable; and
a condenser for condensing the chemical compound from which hydrogen is hardly obtainable by distillation or fractional distillation of the raw material.

35. The system for manufacturing hydrogen according to claim 34, wherein
the additive for breaking the azeotropic relation may be one selected from the group consisting of sodium carbonate, sodium chloride, sodium acetate, potassium chloride, potassium acetate, potassium iodide, calcium chloride, calcium bromide, barium chloride, magnesium chloride, and magnesium bromide.
